(19) United States
(12) Patent Application Publication
(10) Pub. No.: US 2009/0173022 A1
(43) Pub. Date: Jul. 9, 2009

(54) Aluminum door and window structure allowing curtains to be joined thereon

(76) Inventor: Feng-Jui Wu, Madou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,179

(22) Filed: Jan. 8, 2008

(51) Int. Cl. E06B 1/14; E06B 1/36; E06B 1/52

(52) U.S. Cl. 52/213

(57) ABSTRACT

An aluminum door/window includes an upper transverse member, which has several curtain rails on an inner side thereof; the curtain rails are formed one above another together with the body of the upper transverse member so as to be inseparable; a lower one of the curtain rails is provided for a first curtain to be directly installed thereon; an extension support member is joined on an upper one of the curtain rails so that a second curtain can be directly installed on the extension support member.

### BACKGROUND OF THE INVENTION

1. Field of the Invention

The present invention relates to an aluminum door and window structure allowing curtains to be joined thereon, more particularly one, which includes an upper transverse member having inseparable curtain rail portions for curtains to be directly joined thereon; thus, there is no need to manufacture separate curtain rails, and the manufacturing cost will reduce.

2. Brief Description of the Prior Art

Aluminum doors and windows are getting popular partly because they allow increased ventilation and natural-light illumination of the room. And, aluminum doors and windows have to be equipped with curtains to prevent people in the room form being subjected to the sun's heat and glare, and adjust natural-light illumination of the room as well as preventing other people from peeping through the aluminum doors and windows.

Shown in FIG. 1 is a currently existing way to join a curtain to an aluminum door/window; an aluminum door/window 1 includes an upper frame part 11, which has screw holes on an inner side thereof, and a curtain rail 13 is secured on the upper frame part 11 by means of fastening elements 12 passed into the screw holes of the upper frame part 11, and a curtain 14 is joined to the curtain rail 13.

Shown in FIG. 2 is another currently existing way to join a curtain to an aluminum door/window; an aluminum door/window 2 includes an upper frame part 21, and hooked support members 22, which have threaded rod parts, and are secured on the upper frame part 21 with the threaded rod parts being passed into the upper frame part 21; a cylindrical rod 23 is supported on the hooked support members 22, and a curtain 24 is joined to the cylindrical rod 23.

The above-mentioned aluminum doors/windows have the following drawbacks: the installing person has to bore the upper frame parts of the aluminum doors/windows with drills therefore it takes relatively much time and labor to install curtains. Secondly, the manufacturers have to manufacture separate curtain rails/hooked support members, and in turn the manufacturing cost will increase.

Therefore, it is a main object of the present invention to provide an improvement on an aluminum door and window structure to overcome the above problems.

### SUMMARY OF THE INVENTION

An aluminum door/window according to an embodiment of the present invention includes an upper transverse member, which has several curtain rails on an inner side thereof; the curtain rails are formed together with the body of the upper transverse member so as to be inseparable, and each have an opening thereon; a lower one of the curtain rails is provided for a first curtain to be directly installed thereon; an extension support member, which has a curtain rail thereon, is joined on an upper one of the curtain rails so that a second curtain can be directly installed on the curtain rail of the extension support member. Thus, it takes less expense to manufacture the present aluminum door/window, and the aluminum door/window allows curtain to be easily and rapidly joined thereon.

The extension support member can be formed with an extending arm protruding farther away from the upper transverse member, and the curtain rail is formed on a tail portion of the extending arm with its opening facing the upper transverse member.

Or alternatively, the extension support member can be formed with a first curtain rail on the front portion of the extending arm, and a second curtain rail on the tail portion of the extending arm; each of the curtain rails has an opening, and the openings face each other; the extension support member further includes a wall portion protruding down from the front portion of the extending arm, and an extending wall portion protruding from a lower end of the wall portion to be propped against the upper transverse member. In addition, the extending wall portion has a joining section to be detained in and hooked over a lower curtain rail of the upper transverse member.

### BRIEF DESCRIPTION OF THE DRAWINGS

The present invention will be better understood by referring to the accompanying drawings, wherein:

FIG. 1 is a sectional view of a currently existing curtain guide rail fitted on an aluminum door/window,

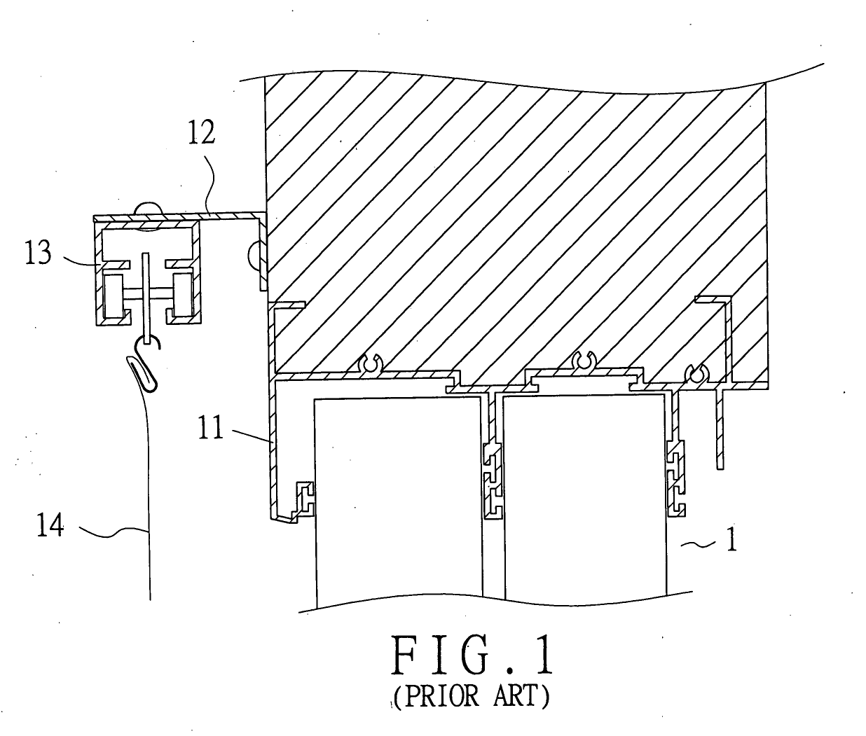

FIG. 2 is a sectional view of another currently existing curtain guide rail installed on an aluminum door/window,

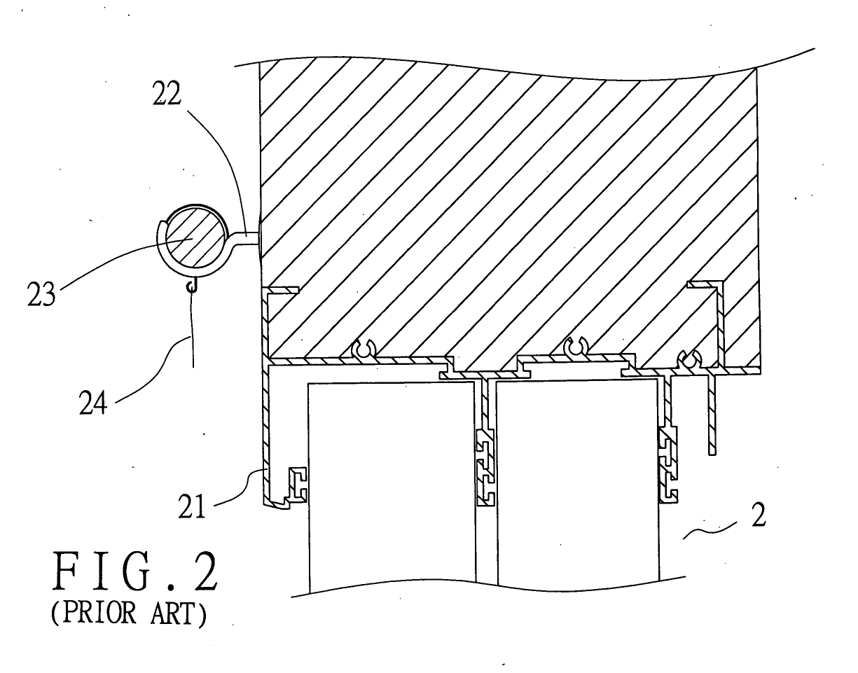

FIG. 3 is a fragmentary exploded perspective view of an aluminum door and window structure of the present invention,

FIG. 4 is a fragmentary exploded sectional view of the aluminum door and window structure shown in FIG. 3,

FIG. 5 is a fragmentary sectional view of the aluminum door and window structure shown in FIG. 3,

FIG. 6 is a fragmentary sectional view of a second preferred embodiment of the present invention, and

FIG. 7 is a fragmentary sectional view of a third embodiment.

### DETAILED DESCRIPTION OF THE PREFERRED EMBODIMENTS

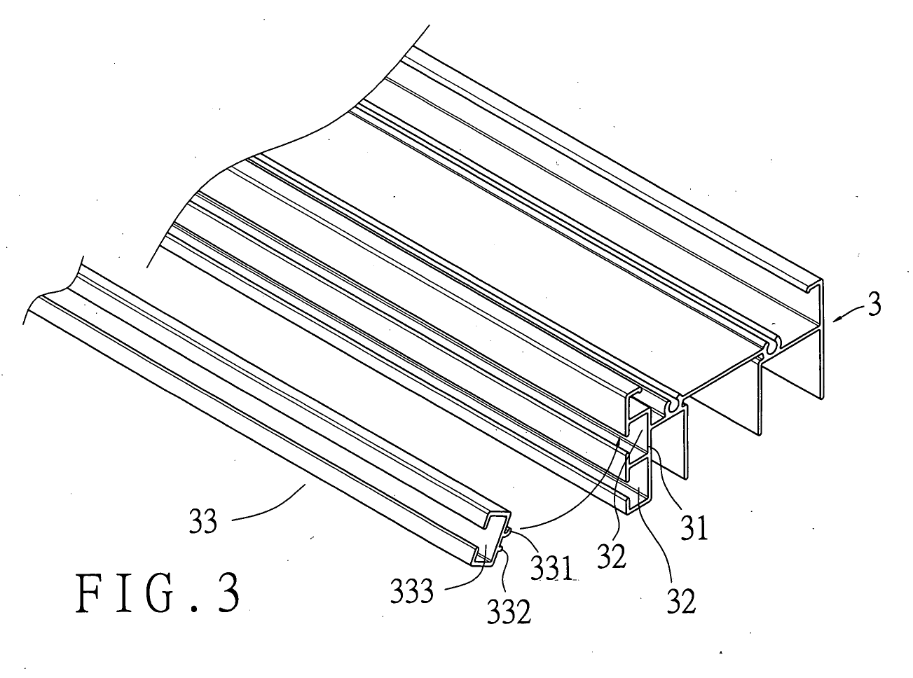

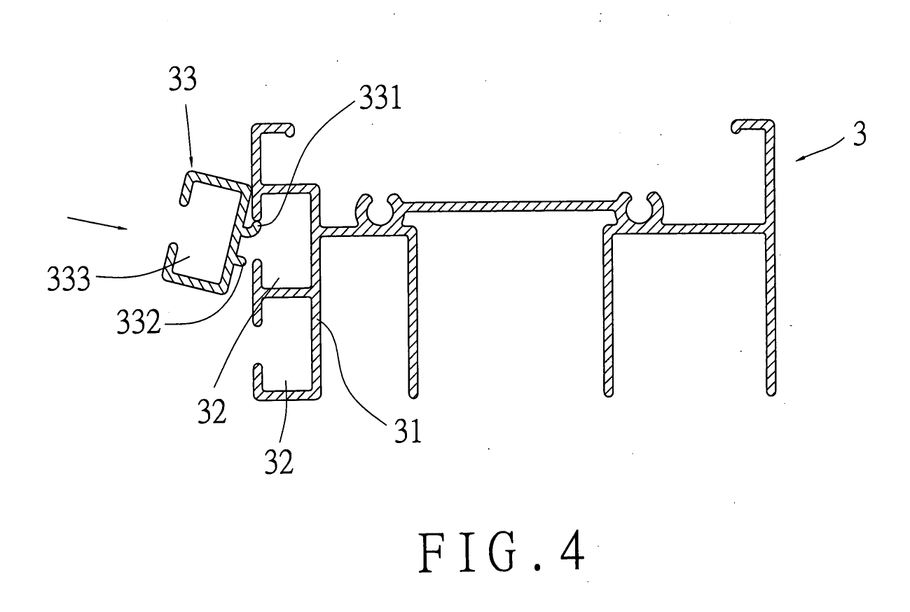

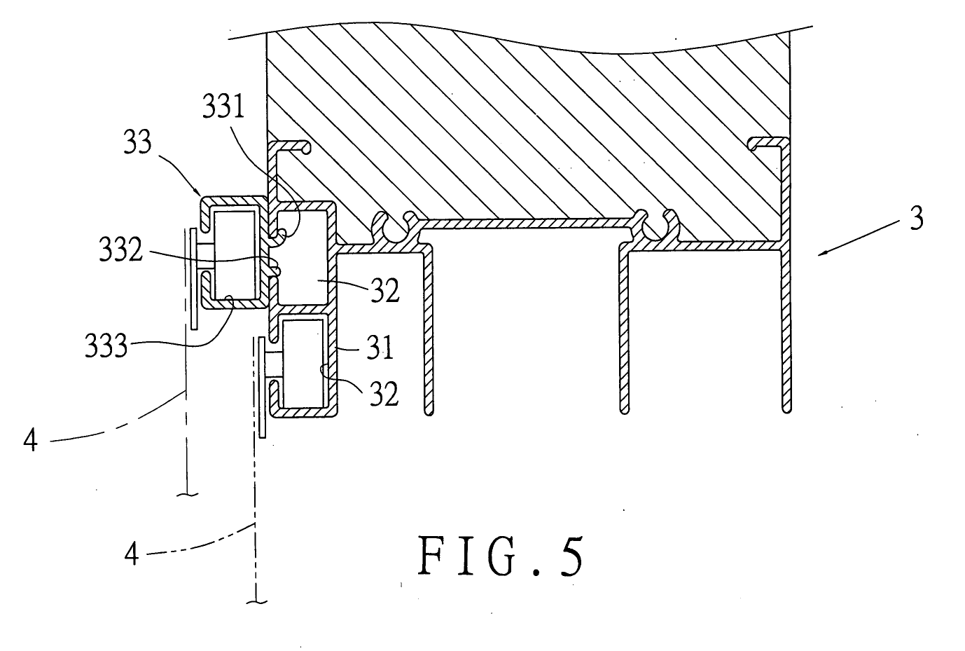

Referring to FIG. 3 to FIG. 5, a first preferred embodiment of an aluminum door and window structure of the present invention includes an upper transverse member 3. The upper transverse member 3 has an inner side 31, which faces an inside of a house. The upper transverse member 3 includes two curtain rails 32 on the inner side 31, which are formed one above the other together with a body of the upper transverse member 3 so as to be inseparable. A first curtain 4 is directly installed on a lower one of the curtain rails 32.

The upper transverse member 3 further includes an extension support member 33, which is joined on an upper one of the curtain rails 32; the lower and the upper curtain rails 32 each have a lengthways extending opening. The extension support member 33 includes a joining section 331, and a propped section 332; the distance between the joining section 331 and the propped section 332 is equal to the breadth of the opening of the upper curtain rail 32; the extension support member 33 is joined on the upper curtain rail 32 of the upper transverse member 3 with the joining section 331 and the propped section 332 thereof being fixedly detained in the opening of the upper curtain rail 32. The extension support member 33 further includes a curtain rail 333, which has an opening facing an inside of the house, and which is provided for another curtain 4 to be supported thereon.

The upper and the lower curtain rails 32 are formed together with a body of the upper transverse member 3 to be inseparable parts of the upper transverse member 3 in the aluminum extrusion process. Therefore, referring to FIG. 3 to FIG. 5, a first (inner) curtain 4 can be directly installed on the lower curtain rail 32 of the upper transverse member 3 either before or after the aluminum door/window is installed. In addition, blocking pieces (not shown) are fitted on two sides of the lower curtain rail 32. After the first curtain 4 has been installed on the aluminum door/window, the extension support member 33 is fixed on the upper curtain rail 32 of the upper transverse member 3 with the joining section 331 and the propped section 332 being detained in the upper curtain rail 32. Next, the other (outer) curtain 4 is installed on the curtain rail 333 of the extension support member 33.

The above preferred embodiment includes only two (the inner and the outer) curtains. Nevertheless, more than two curtains can be installed on an aluminum door/window according to the present invention; taking an aluminum door/window with three curtains as example, in assembly, first a first curtain 4 is installed on a lowermost one of curtain rails 32 of an upper transverse member 4 of the aluminum door/window. Next, a first extension support member 33 is fixedly joined on an intermediate one of the curtain rails 32, which is next to the lowermost curtain rail 32, and a second curtain 4 is installed on the first extension support member 33. And, a second extension support member 33 is fixedly joined on an uppermost one of the curtain rails 32 of the upper transverse member 3, which is above and next to the intermediate curtain rail 32; the second extension support member 33 protrudes farther away from the upper transverse member 3 than the first extension support member 33. And, a third curtain 4 is installed on the second extension support member 33.

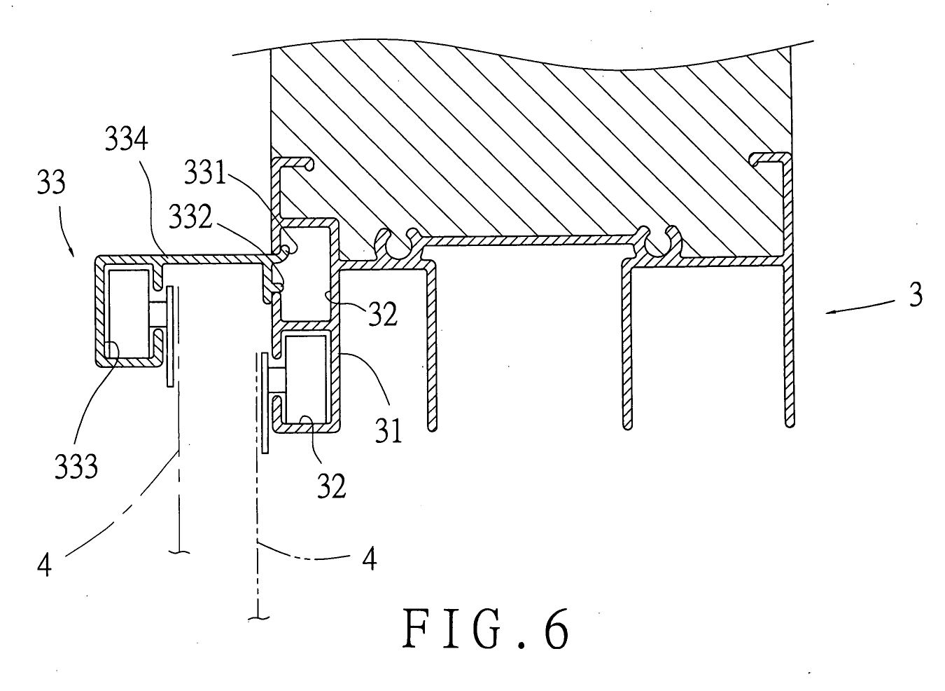

Shown in FIG. 6 is the second preferred embodiment of the present invention, which includes an extension support member 33; the extension support member 33 includes an extending aim 334, and a curtain rail 333, which is formed on a tail portion of the extending arm 334, and which has an opening facing the upper transverse member 3.

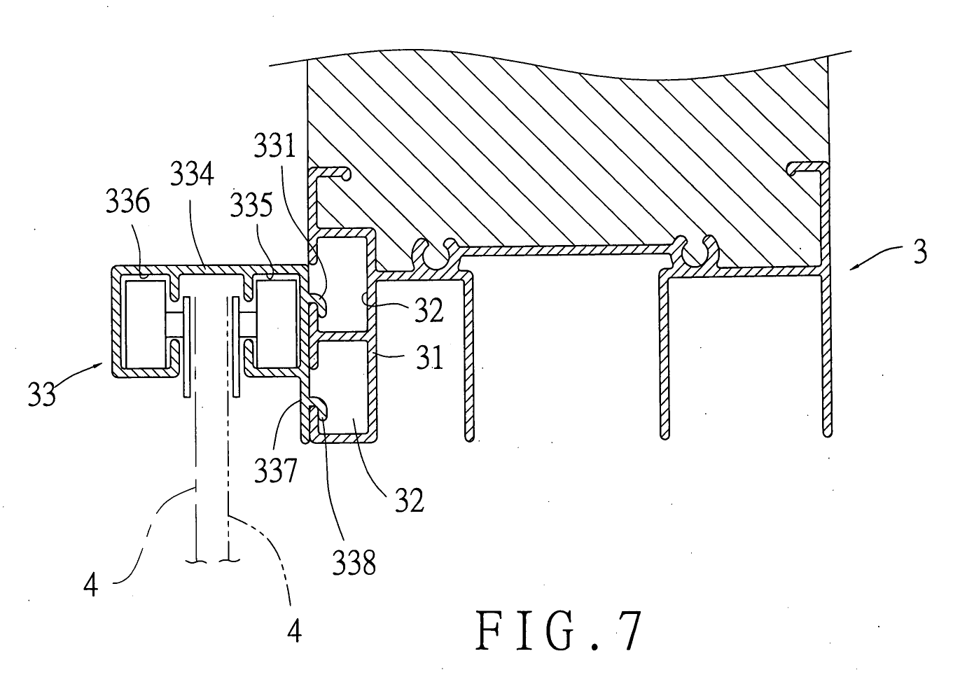

Shown in FIG. 7 is the third preferred embodiment of the present invention, which includes an extension support member 33; the extension support member 33 includes an extending arm 334, a first curtain rail 335 formed on a front portion of the extending arm 334, a second curtain rail 336 on a tail portion of the extending arm 334, a wall portion (not numbered) protruding from the front portion of the extending arm 334, and an extending wall portion 337 protruding from a lower end of the wall portion to be closely in touch with and propped against the upper transverse member 3; each of the first and the second curtain rails 335 and 336 has an opening thereon, and the openings of the curtain rails 335 and 336 face each other. Furthermore, the extension support member 33 includes a joining section 338, which protrudes from the extending wall portion 337 to be hooked over the lower curtain rail 32 of the upper transverse member 3.

From the above description, it can be seen that the aluminum door and window structure of the present invention has the following advantages over the prior arts:

1. Curtain rails are formed together with the body of the upper transverse member of the present invention to be inseparable from the upper transverse member. Therefore, it is not necessary to manufacture separate curtain rails, and it takes less expense to manufacture the aluminum door/window of the present invention.

2. The upper transverse member of the present invention has the curtain rails, which allow curtains to be installed thereon without boring the upper transverse member or using threaded fixing elements (screws). Therefore, it takes relatively little labor and time to install curtains on the aluminum door/window of the present invention.

What is claimed is:

1. An aluminum door and window structure allowing curtains to be joined thereon, comprising
an upper transverse member, the upper transverse member having a plurality of curtain rails on one side thereof, which are formed one above another together with the upper transverse member so as to be inseparable; a lower one of the curtain rails having a first curtain installed thereon; and
an extension support member joined on an upper one of the curtain rails; said upper curtain rail having a second curtain installed thereon.

2. The aluminum door and window structure allowing curtains to be joined thereon as claimed in claim 1, wherein the curtain rails each have blocking pieces on two sides thereof.

3. The aluminum door and window structure allowing curtains to be joined thereon as claimed in claim 1, wherein said upper curtain rail of the upper transverse member has an opening, and the extension support member has a joining section, and a propped section, and is joined on said upper curtain rail with the joining section and the propped section being fixedly detained in the opening of said upper curtain rail.

4. The aluminum door and window structure allowing curtains to be joined thereon as claimed in claim 3, wherein the extension support member includes an extending arm, and a curtain rail on a tail portion of the extending arm.

5. The aluminum door and window structure allowing curtains to be joined thereon as claimed in claim 1, wherein the extension support member includes an extending arm, a first curtain rail on a front portion of the extending arm, and a second curtain rail on a tail portion thereof;
each of the first and the second curtain rails having an opening thereon; the openings of the first and the second curtain rails facing each other; the extension support member including a wall portion protruding from the front portion of the extending arm; the extension support member further including an extending wall portion protruding from a lower end of the wall portion to be propped against the upper transverse member; the extending wall portion having a joining section to be detained in and hooked over a lower one of the curtain rails of the upper transverse member.
